(19) United States
(12) Patent Application Publication
(10) Pub. No.: US 2020/0021986 A1
(43) Pub. Date: Jan. 16, 2020

(54) METHOD OF CONNECTING A NETWORK APPARATUS TO WIFI NETWORK AND WIFI SPEAKER

(71) Applicant: Tymphany Acoustic Technology (Huizhou) Co., Ltd., Huizhou City (CN)

(72) Inventors: Sheng-Ping WANG, Huizhou City (CN); Lun-Hao CHANG, Huizhou City (CN)

(21) Appl. No.: 16/505,134

(22) Filed: Jul. 8, 2019

(30) Foreign Application Priority Data
Jul. 11, 2018 (CN) 201810756317.6

(51) Int. Cl. H04W 12/06; H04W 4/80; H04W 12/00; H04W 76/14

(52) U.S. Cl. CPC H04W 12/0608; H04W 76/14; H04W 12/003; H04W 4/80

(57) ABSTRACT

A network apparatus has a WiFi network module and a short range communications module. A method of connecting the network apparatus to a WiFi network includes providing a connection apparatus, where the connection apparatus is already connected to the WiFi network by using a WiFi account number and a password, and the connection apparatus has a short range communications module corresponding to the network apparatus; automatically pairing the network apparatus with the connection apparatus by using the short range communications modules of the connection apparatus and the network apparatus; and automatically transferring the WiFi account number and the password of the connection apparatus to the network apparatus by using the short range communications modules of the connection apparatus and the network apparatus, and connecting the network apparatus to the WiFi network by using the WiFi network module.

### CROSS REFERENCE TO RELATED APPLICATIONS

This application claims priority under 35 U.S.C. § 119 to Chinese Patent Application No. CN 201810756317.6, which was filed on Jul. 11, 2018, and which is herein incorporated by reference.

### BACKGROUND

### Technical Field

This disclosure relates to a method of connecting to WiFi for a network apparatus and a WiFi speaker, and in particular, to a WiFi speaker using Bluetooth low energy (BLE) communication and a method of connecting to a WiFi network.

### Related Art

If an existing network apparatus, for example, a smart sound box, a smart refrigerator, a smart electric lamp, or a smart air conditioner, is intended to connect to a WiFi network, a mobile phone is usually used for control, that is, a WiFi account number (SSID) and a password need to be displayed and entered by using the mobile phone, so that a network connection can be completed.

In addition, for the network apparatus, an external apparatus (such as a computer) may alternatively be used to start a browser and enter an account number and a password on a particular web page, to complete a connection to the WiFi network.

However, in the foregoing prior art, a user needs to enter an account number and a password. This is really inconvenient for a user without a good memory.

### SUMMARY

In view of the above, this disclosure provides a method of connecting a network apparatus to a WiFi network. The network apparatus has a WiFi network module and a short range communications module. The method in this disclosure includes: providing a connection apparatus, where the connection apparatus is already connected to the WiFi network by using a WiFi account number and a password, and the connection apparatus has a short range communications module corresponding to the network apparatus; automatically pairing the network apparatus with the connection apparatus by using the short range communications modules of the connection apparatus and the network apparatus; and automatically transferring the WiFi account number and the password of the connection apparatus to the network apparatus by using the short range communications modules of the connection apparatus and the network apparatus, and connecting the network apparatus to the WiFi network by using the WiFi network module.

In some embodiments, the short range communications modules are BLE modules, and a same user-defined profile is set for the BLE modules of the network apparatus and the connection apparatus.

In some embodiments, the short range communications module of the connection apparatus is set in a scanning mode, and the short range communications module of the network apparatus is set in an advertising mode. When the network apparatus is connected to the WiFi network by using the WiFi network module, the short range communications module of the network apparatus is automatically changed to be in the scanning mode.

In addition, this disclosure further provides a WiFi speaker, and the WiFi speaker includes a WiFi network module and a short range communications module. The short range communications module is automatically paired with a connection apparatus by using a user-defined profile, a WiFi account number and a password of the connection apparatus are automatically received by using the short range communications module, and the WiFi speaker is automatically connected to a WiFi network by using the WiFi network module.

In some embodiments, the short range communications module is a BLE module.

### BRIEF DESCRIPTION OF THE DRAWINGS

The present invention will become more fully understood from the detailed description given herein below for illustration only, and thus are not limitative of the present invention, and wherein:

FIG. 1 is a method flowchart of an embodiment of a sound output apparatus according to this disclosure;

FIG. 2 is a schematic diagram of a connection process of a connection apparatus;

FIG. 3 is a schematic block diagram of an embodiment of a sound output apparatus according to this disclosure; and

FIG. 4 is a schematic diagram of a determining process of an embodiment of a sound output apparatus according to this disclosure.

### DETAILED DESCRIPTION

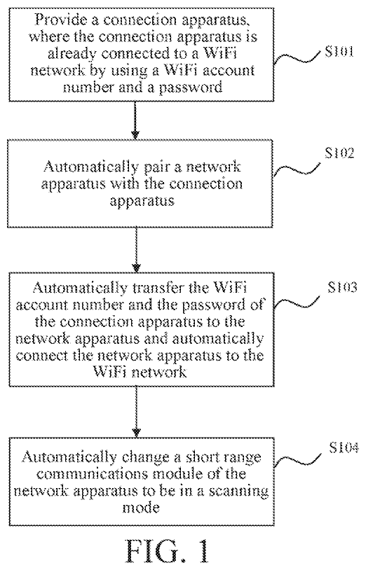

Referring to FIG. 1, FIG. 1 is a flowchart of a method of connecting a network apparatus to a WiFi network. First, connection apparatus is provided (step S101), where the connection apparatus is already connected to a WiFi network by using a WiFi account number (SSID) and a password, and the connection apparatus has a short range communications module corresponding to the network apparatus. In other words, according to the method in this disclosure, the network apparatus is connected to a WiFi network after the connection apparatus already connected to the WiFi network. Therefore, in this step, the connection apparatus needs to be first provided, and the connection apparatus is already connected to the WiFi network by using the WiFi account number and the password.

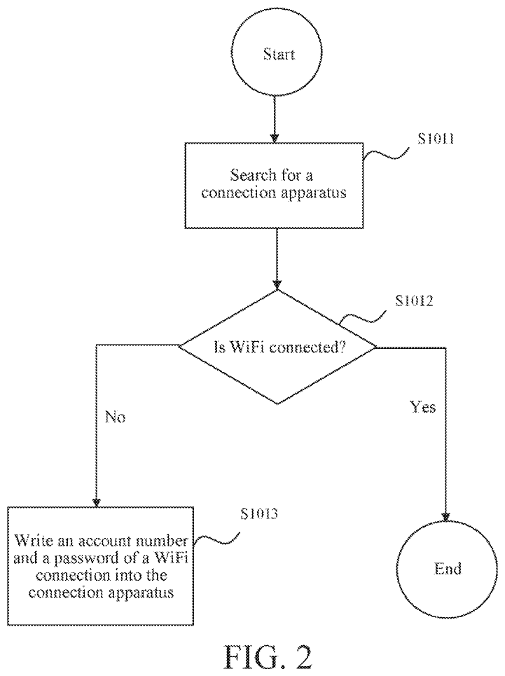

Referring to FIG. 2, for example, a connection process of the connection apparatus may be controlled by using a mobile phone application (app.). The connection apparatus in this disclosure may be a WiFi speaker. Then, the mobile phone app is used to search for the connection apparatus by using Bluetooth communication between a mobile phone and the WiFi speaker (step S1011). Then, it is determined whether the connection apparatus is connected to WiFi (step S1012). If the connection apparatus is not connected, then an account number and a password of a WiFi connection is written into the connection apparatus (step S1013), so that the connection apparatus completes the connection.

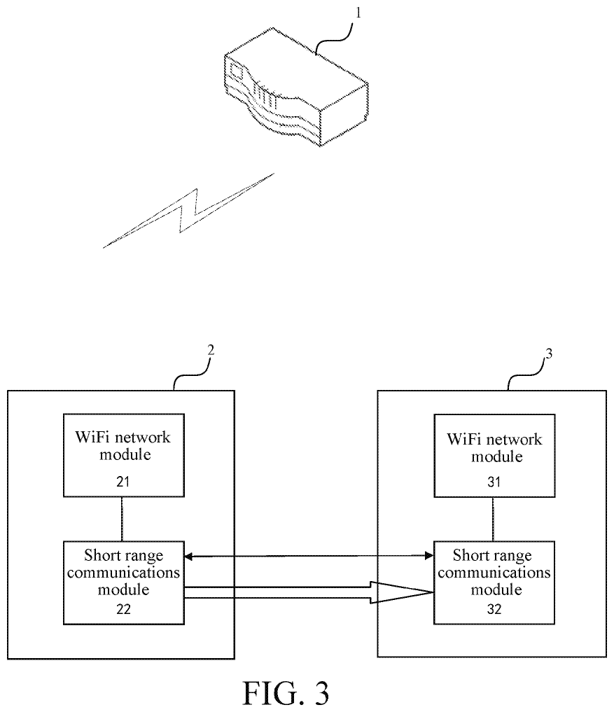

Referring to FIG. 3 as well, a connection apparatus 2 is already connected to the WiFi network by using the WiFi account number and the password, in other words, connected to the WiFi network by using a router 1. The router 1 in this embodiment is merely used as an example for description, and any apparatus (such as an access point (AP) and HUB) connected to a network may be used. A network apparatus 3 in this disclosure is a network apparatus (such as the WiFi speaker) that is not connected to WiFi, and a WiFi connection may be accomplished by using the method in this disclosure. Detailed descriptions are provided below.

As shown in FIG. 3, the network apparatus 3 includes a WiFi network module 31 and a short range communications module 32. The connection apparatus 2 also includes a WiFi network module 21 and a short range communications module 22. Referring back to FIG. 1, next, the network apparatus 3 is automatically paired with the connection apparatus 2 by using the short range communications module (step S102). In some embodiments, the short range communications module 22 may be a BLE module, a Zigibee module, or the like. Especially, the short range communications modules 22 and 32 are BLE modules, and when the network apparatus 3 is close to the connection apparatus 2, and a distance between the network apparatus 3 and the connection apparatus 2 is relatively small (for example, the distance is less than two meters), automatic paring can be completed.

In some embodiments, for example, when the short range communications modules 22 and 32 are BLE modules, a user-defined profile is compliant to the General Access Profile (GAP) protocol is set in the short range communications modules 22 and 32, so that when the network apparatus 3 is close to the connection apparatus 2, the network apparatus 3 and the connection apparatus 2 can identify each other and automatically complete pairing.

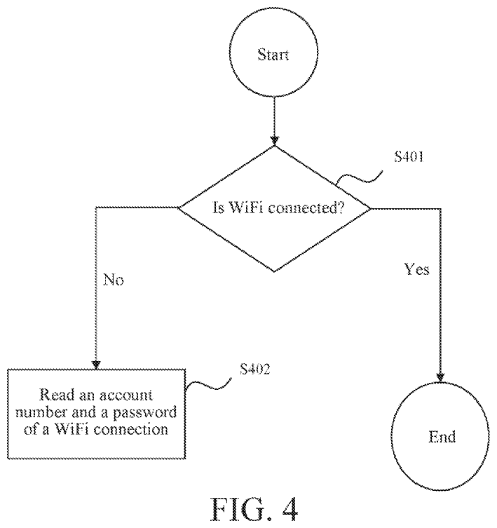

Referring to FIG. 4 first, after the network apparatus 3 and the connection apparatus 2 identify each other and complete the pairing, it is determined whether the network apparatus 3 is connected to the WiFi network (step S401). When the determining result is “no”, that is, the network apparatus 3 is not connected, then an account number and a password of a WiFi connection is read (step S402). When the determining result is “yes”, the determining process ends.

Referring back to FIG. 1, next, the WiFi account number and the password of the connection apparatus 2 are automatically transferred to the network apparatus 3 by using the short range communications modules 22 and 32 of the connection apparatus 2 and the network apparatus 3 (step S103). For example, the short range communications modules 22 and 32 may be designed by setting characteristics for compliant to the Generic Attribute Profile (GATT) protocol and complete the data transmission. When receiving the WiFi account number and the password, the network apparatus 3 may be connected to the WiFi network by using the WiFi network module 31, that is, be connected to a router 1 (or another same connection apparatus) the same as the connection apparatus 2. Further, for the BLE modules 22 and 32, a profile compliant to the GATT protocol may be defined, and a unique identifier (UUID) may be user-defined to identify a data block. The characteristics of the short range communications modules 22 and 32 include reading, writing, notification, and/or the like, and in addition, an attribute of a descriptor may be further used to describe values of the characteristics. Data transmission between the short range communications modules 22 and 32 is accomplished by using the GATT protocol. For example, when receiving an account number and a password for connecting to WiFi, the short range communications module 32 may transfer an ICMP packet to an IP physical location to verify whether a connection is completed.

In some embodiments, the short range communications module 22 (for example, a BLE module) of the connection apparatus 2 is set in a scanning mode, and the short range communications module 32 (for example, a BLE module) of the network apparatus 3 is set in an advertising mode. When the network apparatus 3 is connected to the WiFi network by using the WiFi network module 31 in step S103, the short range communications module 32 (for example, a BLE module) of the network apparatus 3 is automatically changed to be in a scanning mode (step S104). For example, the short range communications module 32 may be converted from a peripheral device to a central device by using a role that is set to conform to the GAP protocol.

The method of connecting to a WiFi network in this disclosure is especially applicable to the WiFi speaker. Therefore, the connection apparatus 2 and the network apparatus 3 may be WiFi speakers. If a user already has a first WiFi speaker (the connection apparatus 2) that is connected to the WiFi network by using the router 1 (or another same connection apparatus), when the user needs to set another (the second) WiFi speaker (the network apparatus 3), the user only needs to use Bluetooth modules (22, 32) of two WiFi speakers (the connection apparatus 2 and the network apparatus 3), and make the second WiFi speaker (the network apparatus 3) close to the first WiFi speaker (the connection apparatus 2), so that automatic pairing can be completed, and the WiFi account number and the password may be transferred to the second WiFi speaker (the network apparatus 3) automatically, to complete a WiFi connection. In this way, when better user experience can be provided, the user does not need to memorize many account numbers and passwords or enter account numbers or passwords any more.

Although this disclosure is disclosed as above by using embodiments, the embodiments are not intended to limit this disclosure. Any person skilled in the art can make some variations and modifications without departing from the spirit and scope of this disclosure. Therefore, the protection scope of this disclosure should be subject to the scope defined by claims.

What is claimed is:

1. A method of connecting a network apparatus to a WiFi network, wherein the network apparatus comprises a WiFi network module and a short range communications module, the method comprising:
providing a connection apparatus, wherein the connection apparatus is connected to the WiFi network using a WiFi account number and a password, and the connection apparatus comprises a short range communications module corresponding to the network apparatus;
automatically pairing the network apparatus with the connection apparatus using the short range communications module of the connection apparatus and the short range communications module of the network apparatus; and
automatically transferring the WiFi account number and the password of the connection apparatus to the network apparatus by using the short range communications module of the connection apparatus and the short range communications module of the network apparatus, and connecting the network apparatus to the WiFi network using the WiFi network module.

2. The method of connecting a network apparatus to a WiFi network according to claim 1, wherein the short range communications modules are Bluetooth low energy (BLE) modules, and the BLE modules of the network apparatus and the connection apparatus are set with the same user-defined profile.

3. The method of connecting a network apparatus to a WiFi network according to claim 2, wherein the short range communications module of the connection apparatus is set in a scanning mode, and the short range communications module of the network apparatus is set in an advertising mode.

4. The method of connecting a network apparatus to a WiFi network according to claim 3, wherein when the network apparatus is connected to the WiFi network by using the WiFi network module, the short range communications module of the network apparatus is automatically changed to be in the scanning mode.

5. A WiFi speaker, comprising:
a WiFi network module; and
a short range communications module,
wherein the short range communications module is automatically paired with a connection apparatus using a user-defined profile,
wherein a WiFi account number and a password of the connection apparatus are automatically received using the short range communications module, and
wherein the WiFi speaker is automatically connected to a WiFi network using the WiFi network module.

6. The WiFi speaker according to claim 5, wherein the short range communications module is a Bluetooth low energy (BLE) module.
